(19) United States
(12) Patent Application Publication
(10) Pub. No.: US 2019/0130414 A1
(43) Pub. Date: May 2, 2019

(54) ONLINE POINT-OF-COMPLAINT SYSTEM WITH REPORTING AND RESOLUTION METHODS IN REAL TIME

(71) Applicant: Marcellus Ellis, Beverly Hills, CA (US)

(72) Inventor: Marcellus Ellis, Beverly Hills, CA (US)

(21) Appl. No.: 16/172,594

(22) Filed: Oct. 26, 2018

Related U.S. Application Data
(60) Provisional application No. 62/578,392, filed on Oct. 28, 2017.

(51) Int. Cl. G06Q 30/00; G06Q 30/02

(52) U.S. Cl. CPC G06Q 30/016; G06Q 30/0263; G06Q 30/0282

(57) ABSTRACT

An online point-of-complaint system with reporting and resolution methods in real time is disclosed. The system comprises an online software platform allowing a user to file a complaint through a mobile device or computer that notifies another participating user of said complaint using evidence. The software includes a means to allow said users to interact and facilitate a resolution and provides a rating score for each user that can be made public online as an ‘experience score’ for the individual providing feedback and a ‘resolution score’ for the other party. The software also provides an advertisement module to send targeted advertisements to the first party. The advertisement module sends the targeted advertisements either at the point of registering a complaint or thereafter to the first party. The advertisements may be sent at the time of registration of complaints or thereafter. An object of the invention is to provide a means of enhancing conflict resolution.

### TECHNICAL FIELD OF THE INVENTION

The present invention relates in general to software, and, more specifically, to an online point-of-complaint system with reporting and resolution methods in real time.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Within the last two decades, mobile communications and the internet have changed the way humans interact around the globe. A majority of goods and services are available at the touch of a button for those who can afford such access. Customers can see if an item is in stock from their home computer and pay for items with their cell phone. Patients can make appointments with their doctors online. Email and online banking have greatly reduced post office and bank visits. The explosion of social media has also impacted interpersonal and commercial reputations. If a person complains of a poor experience they had at a merchant's place of business on a social media platform such as Facebook, the report can damage a merchant's reputation with no recourse, particularly if they realize it days after reported. In some instances a customer will notify agencies like the Better Business Bureau to report a complaint or solve a dispute, however the process may take months or even years to get action.

In other instances, a party may opt to consult with an attorney for dispute resolution only to find out the issue may not be worth the cost of pursuing. In these instances both parties may lose: a complainer may fail to patronize a business again and a merchant may fail to correct a problem in a timely fashion to prevent further customer attrition. While many interactions have been expedited using the internet, other interactions have yet to become digitally enhanced. Popular web sites such as Yelp, Trip Advisor, and Angie's List offer online reviews of consumer experiences, however these sites fail to offer a means of facilitating any resolution between parties when conflicts arise. Often times a business or organization has no means to correct a situation before negative feedback is posted on social media, sometimes even during a visit, by an unsatisfied consumer and their business can suffer. Online software mediation service inventions have started to emerge as a means to facilitate conflict resolution between parties before fragile reputations are impacted.

U.S. Patent No. 20010044729A1 granted to Pomerance discloses an automated complaint management system but does not include a reputation score or a survey option for stakeholders. U.S. Patent No. 20020147603A1 granted to Slate et. al. teaches an automated complaint management system but does not assign a reputation score for any parties. U.S. Patent No. 20120166283A1 granted to Berliner discloses an electronic system and method for dispute management that does not incorporate a reputation score, publicly-available transaction history, or any multimedia inputs for complaint options. U.S. Patent No. 20120016943A1 granted to Greenberg et. al. discloses a bargained for exchange, guided discovery, and dispute resolution system that does not include publicly-available transaction history or post monitoring and follow up options. U.S. Pat. No. 5,895,450A granted to Sloo teaches of a method and apparatus for handling complaints but does not incorporate stakeholder surveys. U.S. Patent Nos. 6330551B1 and 20170039662A1 granted to Burchetta et. al. and McKenna et. al. respectively teach of dispute resolution and grievance processes but do not allow for stakeholder reputation scores, publicly-available transaction history, participant surveys, options to bring in outside mediators, or post monitoring functions. Other dispute resolution systems include popular internet sites that are not patented, but do offer arbitration or mediation such as the National Arbitration Forum (NAF) at http://www.arbforum.com. The NAF web site offers a set of resources available for arbitration on the internet and has a reputation for handling debt collection cases.

Most of the existing online dispute resolution (ODR) generates revenue through regular subscription and advertisements. These advertisements are general and are not specified to specific customers. These advertisements generate little business as these are not targeted to the customer. Therefore, there is a need of a system that generates targeted advertisements at the time of complaints registered by the first party. Further, the system should send advertisements of the competitors of the second party to the first party to generate the targeted audience of the advertisers and at the right time, when the first party needs one.

It is to these ends that the present invention has been developed.

### BRIEF SUMMARY OF THE INVENTION

To minimize the limitations in the prior art, and to minimize other limitations that will be apparent upon reading and understanding the present specification, the present invention describes an online point-of-complaint system with reporting and resolution methods in real time.

It is an objective of the present invention to provide an online point-of-complaint system with reporting and resolution methods in real time that may comprise a proprietary software.

It is another objective of the present invention to provide an online point-of-complaint system with reporting and resolution methods in real time that may comprise a real-time complaint system.

It is another objective of the present invention to provide an online point-of-complaint system with reporting and resolution methods in real time that may comprise a plurality of user types.

It is another objective of the present invention to provide an online point-of-complaint system with reporting and resolution methods in real time that may comprise a central database.

It is another objective of the present invention to provide an online point-of-complaint system with reporting and resolution methods in real time that may enhance mediation and resolution between patrons and merchants.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 schematically presents an online point-of-complaint system with reporting and resolution methods in real time, as contemplated by the present disclosure; and

FIG. 2 schematically presents a computing system configured to carry out and actualize methods and tasks described herein, in accordance with aspects of the present disclosure.

### DETAILED DESCRIPTION OF THE INVENTION

Certain terminology is used in the following description for reference only and is not limiting. Unless specifically set forth herein, the terms “a,” “an,” and “the” are not limited to one element, but instead should be read as meaning “at least one.” The terminology includes the words noted above, derivatives thereof, and words of similar import.

The system herein disclosed and described provides a solution to the shortcomings in the prior art through the disclosure of an online point-of-complaint system with reporting and resolution methods in real time. An object of the invention is to enhance mediation and resolution between stakeholders with access to information technologies as a “point-of-complaint.” A user can file a complaint against another participating party using the invention's software application, reach a person of influence, and get results within a predetermined time frame. For example, a temporary contractor notices a hazardous condition while on the job and informs a manager. After nothing is done, and knowing their time at the job is limited, they opt to use the aforementioned invention rather than notifying the occupational health and safety administration, which might take weeks to investigate. The contractor uses their laptop to file a complaint using the invention's application and an upper-level manager, who also uses the invention, is notified of the problem immediately and takes the necessary actions to address the situation quickly. This real-time complaint and response is an example of the “point-of-complaint” feature the invention offers. When a successful resolution to conflicts is reached using the invention, they are designed to occur very rapidly; ideally at the point a user complains. In other words, the purpose of the invention is to resolve conflicts quickly.

Another object of the invention is to enhance evidence submission during the complaint process. A party with a complaint can gather evidence using a cell phone by recording the scene using video, audio, and still pictures and upload them to the invention's application. Another participating party is notified of the complaint and sent the multimedia evidence to verify the complaint. For example, a customer observes a rodent in a supermarket aisle and notifies employees. When no action is taken after an hour, the customer records the animal scavenging through product using a cell phone and uploads it to the invention's software application. The customer then attaches the images to a complaint form within the application and they are sent to the establishment, who is also a member of the service, within seconds. The invention immediately notifies the manager on duty of the issue via a multimedia text message allowing them to meet with the customer and rectify the situation before the customer leaves the establishment.

Another object of the invention is to build and maintain an online reputation. A party that responds quickly and effectively to filed complaints using the mediation and resolution tools in the invention is given a resolution score that can enhance their popularity and online public profile. For example, a hotel patron complains about an issue with the hotel's hot tub to the front desk at their day of departure finds nothing has been done. Instead of reporting the complaint on a website such as Yelp, the customer uses the invention to bypass front desk personnel and notify upper management of the problem before leaving the establishment. Upon being notified, the management has an opportunity to apologize to the customer and correct the situation and even make amends, such as by providing a discount or gift certificate, thereby providing a quick resolution. The invention performs follow up verification with both parties through the application software. If proper response conditions are met through an algorithm and both parties agree, the hotel receives a positive response score. If the response is unsatisfactory, the hotel receives a negative score. The scores are posted on the invention's website and are made available for public viewing. Higher response scores can lead to an increase in patron brand loyalty. Lower scores can motivate an organization to improve customer relations. Parties who file complaints also receive an experience score. If the algorithms interpret a user as filing chronic frivolous complaints, a low experience score is assigned. A user filing a complaint having a lower experience score will result in less of an impact on the other party's resolution score during subsequent complaints. Users also have the option of placing correspondences with another party into the public domain if a resolution is not achieved using the invention's posting option. For example, if a customer has a dialog with the hotel manager that is not satisfactory, the customer can have the software post the entire dialog on the invention's web site for public viewing.

Another object of the invention is to increase accessibility to management. As in the case of the previous hotel complaint, the customer had the ability to use the invention to bypass unresponsive front-desk personnel and complain directly to those on the management level. Customers can feel empowered and satisfied that their complaint is being heard when they receive a text message or personal phone call from a concerned manager using the invention. Complaints can also be reported more accurately rather than going through several employees before reaching someone in charge. Increased accessibility to upper management can improve overall customer relations when complaints are addressed quickly and customers know management cares about customer satisfaction.

Yet another object of the invention is to protect a user's identity when filing a complaint. Users of the invention have the option to place a complaint anonymously to avoid any negative repercussions. For example, in the previous example of the employee who continuously notifies managers of a hazardous condition at work can use the invention to file a complaint anonymously without fear of retribution or being fired. In addition, if the whistleblower were to notify the Occupational Health and Safety Administration, agency representatives may not respond in a timely fashion.

Another object of the invention is to provide a method to automate fraudulent or frivolous claim detection and minimization via artificial intelligence. For example, if a business competitor becomes a member and begins making numerous complaints, also known as “flaming,” against another competitor in order to sabotage their online reputation, an algorithm in the software will detect and automatically halt the complainer. Said algorithm having flag markers that include, but are not limited to, several complaints within a short time span, complaints being of a similar nature, complaints having key words unrelated to another member, a complainer already having a large number of filed complaints, and the like.

Another object of the invention is to provide a method to facilitate conflict resolution automatically, also using artificial intelligence technologies. In this instance, the software prompts parties to interact and steps them through the stages of guided resolution with pop-up screens and a running log of discussion highlights. Algorithms may include resolution prompts based on, but not limited to, asking members to outline their complaints in writing before beginning a dialog, having members establish goals and expected outcomes, extract and display relative laws related to the issues at hand, recognizing irrational thoughts from members that do not contribute to a resolution, allowing members to air grievances and emotions as part of the process, and the like.

Another object of the invention is to provide a method to gauge evidence validity using geofencing technology. Geofencing is the use of global positioning systems to create a virtual geographic boundary, enabling software to trigger a response when a mobile device enters or leaves a particular area. In this invention, geofencing is used to assess the validity of incoming evidence. For example, if a user is sending complaints about a store clerk and is not on the premises, the geofencing would notify the software algorithm and a lesser weight would be applied to the complaint and, in extreme cases, may even retract a complaint.

Another object of the invention is to enhance conflict resolution follow up. Parties involved in mediations using the invention receive questionnaires and surveys periodically to follow up on agreed response actions to complaints via text messages and emails. Cases can be re-opened by parties if follow through is not being maintained which can subsequently impact resolution scores.

Another object of the present invention is to provide an advertising module to send targeted advertisements to the member 100. The advertisement module sends the advertisements of the competitors of the merchant to the member 100. Further, the advertisements may relate to the complementary product and services related to the business of the merchant. The advertisement module sends the targeted advertisements either at the point of registering of complaint or thereafter to the member 100. The advertisement module shares conflict data to third party advertisement networks, such as Google ad sense.

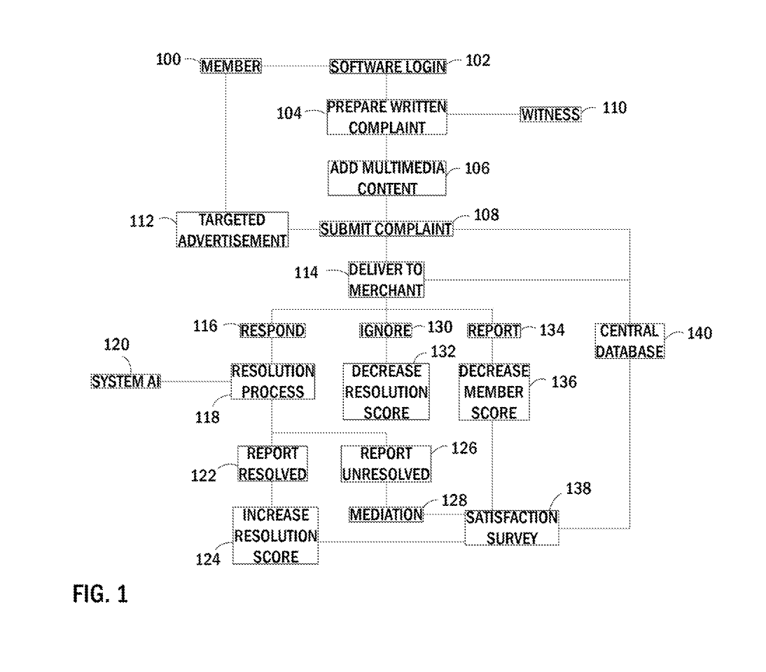

The illustration of FIG. 1 schematically presents an online point-of-complaint system with reporting and resolution methods in real time, as contemplated by the present disclosure. A member 100 may begin using the system by logging in to the proprietary software 102 user interface to prepare a written complaint 104. An embodiment of the system may be comprised of a mobile device application allowing a member 100 to include multimedia content 106 such as, but not limited to, texts, emails, short message service (SMS), and the like. The proprietary software may be coded using C++, Java, or any appropriate programming language, and may be compatible with desktop and mobile device software such as, but not limited to, Android, Windows, Apple, Linux, etc. The aforementioned software may also be compatible with cloud-based platforms.

Once the member 100 has prepared the written complaint 104 and added any appropriate multimedia content 106 the complaint may be submitted 108 to the system. The complaint may be delivered to the appropriate merchant personnel 114, which may be management, human resources, or social media personnel for the merchant, receiving said complaint using the invention software and placing a call to the member 100. In the alternative the member 100 may have the option to keep their identity anonymous. The aforementioned software also has artificial intelligence capabilities via algorithms that monitor the number of complaints over certain time frames, as well as text content through optical character recognition and voice and facial recognition that can detect trends in text, video, and audio files in order determine whether or not fraudulent or frivolous complaints are being generated by a user.

The software then allows members to record the resulting interaction as resolved 122, still in process, or unresolved 126. The invention also allowing members 100 to resolve complaints remotely via email, text messages, SMS, and the like. The software may also have artificial intelligence (AI) 120 capabilities to provide automated resolution guidance 118 to parties engaged in a mediation 128 as an option. The AI may detect trends, as stated previously, and prompt users to respond to queries based on the latest proven resolution and conflict theory.

Algorithms in the software may track, increase, and decrease resolution scores based upon an outcome reported by the member 100 and being observed online publicly by other consumers. The member 100 may use a mobile phone application send an encrypted and or anonymous private message to participating merchant manager 114 that only they can see. The encryption methods may include Triple DES, RSA, Blowfish, Twofish, and AES, and the like. The aforementioned merchant may have a plurality of options using the invention, including, but not limited to, deeming a complaint legitimate and acting to resolve it 116, ignoring said complaint 130, and deeming said complaint frivolous and reporting 134 it to the system. When the complaint is deemed legitimate 116 and resolved 122, said merchant's resolution score may be increased 124 and made available for public online viewing. The member 100 may choose to withdraw or to seal the complaint, which may be later unsealed if a repeat complaint is filed. When said merchant ignores a complaint 130 their merchant score may be decreased 132 and available for public viewing. If a merchant fails to respond to a complaint within 48 hours, the complaint may be automatically published. When a merchant deems a complaint message frivolous 134, the member's 100 “experience” score may be decreased 136 and an algorithm in the software may cause that member's 100 present and future complaints to have less weight in future resolution scores. The software also allows members 100 to obtain outside resources of a mediator 128 or legal intervention during non-resolution outcomes 126. Another option being satisfaction surveys 138 for members that may critique other members or the service itself.

The system network comprised of member 100 input variants includes, but is not limited to, a desktop computer, a tablet, a cell phone, and the like. Evidence that may be submitted may include options such as, but not limited to, audio recordings, video recordings, text-based messages, and the like. The system may be connected by means of the invention's cloud-based network which may include linked servers having the aforementioned algorithmic functions including, but not limited to, a member database, experience scoring, resolution scoring, fraud AI, resolution facilitation, and post resolution monitoring. The member 100 devices and the aforementioned cloud servers may be connected by a plurality of wire and wireless links such as, but not limited to, ethernet cables with routers, WiFi services, cell phone transmission frequencies, and the like.

The central database 140 of the system may include a real time evidence database and a location evidence database. The real time evidence database stores received data from members 100. Example of data includes, but is not limited to, phone numbers, first name, last name, area of conflict, conflict with, etc. The location evidence database stores location details.

The graphical user interface may display a plurality of modules. The processor is coupled to the graphical user interface and the memory unit for processing the plurality of modules. The plurality of modules include a registration module for registering users to allow them to resolve their conflict, a record evidence module for allowing the member 100 to record evidence of the conflict in real time, a location device match module coupled to the location evidence database for authenticating the evidence submitted by the member 100 by matching with the location of the merchant, a contact module for contacting the merchant along with the evidence submitted by the member 100 to confirm about the conflict and further receiving status from the merchant in regard to the conflict, and a conflict status module updating the status of the conflict to being resolved on receiving confirmation from the member 100.

In another preferred embodiment of the present invention, the plurality of modules further include a witness module for allowing the member 100 to send a code to a witness 110 registered on the database to vouch for and submit their own evidence for corroboration with the evidence submitted by the member 100 along with the code, wherein the code authenticates the witness.

In another preferred embodiment of the present invention, the plurality of modules further include a witness collaboration module for finding a witness 110 in the vicinity of the member 100. The system identifies registered users in the vicinity of the conflict and sends them a request to submit their evidence on the conflict. The users are identified based upon GPS location, IP address of the phones used by the registered users, and other similar means to identify the location.

In another preferred embodiment of the present invention, the plurality of modules further include a lodge official complaint module for allowing the member 100 to lodge formal complaints by submitting evidence, notes, and narrative against the merchant. The notes contain the raw data noted by the member 100 during the conflict. The narration is created after the occurrence of conflict and the registered user write detailed analysis of the events occurred during and after the conflict.

In another preferred embodiment of the present invention, the plurality of modules further include a respond module to receive response from the merchant on the lodged formal complaints, and further updates the conflict status module based on receiving confirmation from the member 100 based on the response from the merchant.

In another preferred embodiment of the present invention, the plurality of modules further include a community appeal module for allowing the third parties to the conflict to provide their opinion to the conflict on evaluating the notes, narrative, and all evidences; and a scoring module assigns scores to each party associated with each conflict on the basis of feedback from the involved parties and the third parties, wherein the scoring module automatically provide scores to detect fraudulent parties and frivolous complainants.

Alternatively, the record evidence module allows the member 100 to upload evidence that contains a recorded phone call between the member 100 and the merchant. Another preferred embodiment of the present invention includes a call-matching module that confirms the phone number of the merchant.

In another preferred embodiment of the present invention, the plurality of modules further includes an artificial intelligence module 120 for performing real time analysis to identify fraudulent and frivolous claims from registered users.

In another preferred embodiment of the present invention, the plurality of modules further includes an advertisement module to send targeted advertisements 112 to the member 100. The advertisement module sends the advertisements of competitors of the complained-against merchant to the member 100. The purpose is to send a targeted advertisement from a competitor, when the member 100 is open to switching from the merchant. The advertisements may also include promotional codes from competitors, thus encouraging switching. The advertising information may be modified on a periodic basis or in response to certain actions of the first party. The advertisement module may further share conflict data to third party advertisement network. The advertisements may be sent at the time of registration of complaints or thereafter. Also, the advertisements may be related to complementary businesses, product and services of the merchant.

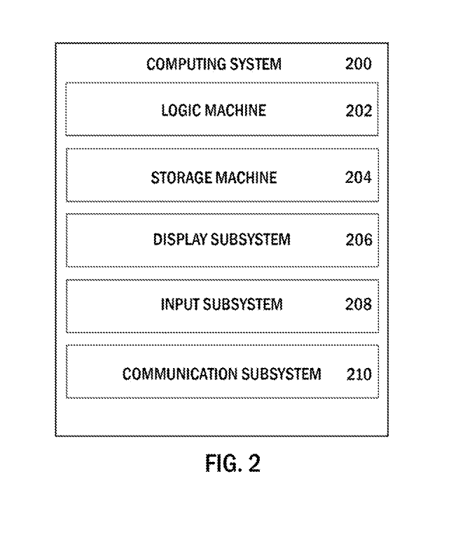

The illustration of FIG. 2 schematically presents a computing system that may represent an embodiment of the present invention. In some embodiments the method is executed on a computing system such as computing system 200 of FIG. 2. For example, storage machine 204 may hold instructions executable by logic machine 202 to provide the method to users. Display subsystem 206 may display the various elements of the method to participants. For example, display subsystem 206, storage machine 204, and logic machine 202 may be integrated such that the method may be executed while being displayed on a display screen. The input subsystem 208 may receive user input from participants to indicate the various choices or user inputs described above. The described method may be executed, provided or implemented to a user on one or more computing devices via a computer-program product such as via an application programming interface (API). FIG. 2 schematically shows a non-limiting exemplary embodiment of a computing system 200 that can enact the method described above. Computing system 200 may be any appropriate computing device such as a personal computer, tablet computing device, gaming device or console, mobile computing device, etc. Computing system 200 includes a logic machine 202 and a storage machine 204. Computing system 200 may include a display subsystem 206, input subsystem 208, and communication subsystem 210. Logic machine 202 may execute machine-readable instructions via one or more physical devices. For example, the logic machine 202 may be configured to execute instructions to perform tasks for a computer program. The logic machine may include one or more processors to execute machine-readable instructions. Storage machine 204 includes one or more physical devices configured to hold or store instructions executable by the logic machine to implement the method. When such methods and processes are implemented, the state of storage machine 204 may be changed to hold different data. For example, storage machine 204 may include memory devices such as various hard disk drives or CD or DVD devices. Display subsystem 206 may visually present data stored on storage machine 204. For example, display subsystem 206 may visually present data to form a graphical user interface (GUI). Input subsystem 208 may be configured to connect and receive input from devices such as a mouse, keyboard, or gaming controller. Communication subsystem 210 may be configured to enable system 200 to communicate with other computing devices. Communication subsystem 210 may include wired and/or wireless communication devices to facilitate networked communication.

While the invention has been described in connection with what is presently considered to be the most practical and preferred embodiments, it is to be understood that the invention is not to be limited to the disclosed embodiments, but, on the contrary, is intended to cover various modifications and equivalent arrangements included within the spirit and scope of the appended claims.

I claim:

1. An online point-of-complaint system, comprising:
a proprietary software;
a central database;
a plurality of functional modules;
a plurality of customer users;
a plurality of merchant stores;
a plurality of merchant users;
a plurality of reputation scores; and
a plurality of resolution scores;
wherein each of said plurality of customer users is associated with a unique customer;
wherein each of said plurality of merchant stores is associated with a unique store;
wherein each of said plurality of merchant users is associated with a said unique store;
wherein one of each of said reputation scores is associated with one of each of said plurality of customer users;
wherein one of each of said resolution scores is associated with one of each of said plurality of merchant stores;
wherein said plurality of customer users, said plurality of merchant stores, said plurality of merchant users, said plurality of reputation scores, and said plurality of resolution scores are stored on said central database; and
wherein said proprietary software comprises a user interface having a complaint submission form.

2. The invention of claim 1,
wherein said unique customer accesses said complaint submission form on said proprietary software, identifies one of said plurality of merchant stores, and enters a complaint text into said complaint submission form;
wherein said unique customer accesses said complaint submission form on said proprietary software, identifies one of said plurality of merchant stores, and enters a multimedia file into said complaint submission form; and
wherein said unique customer submits said complaint submission form on said proprietary software as a complaint, and said complaint is delivered to said plurality of merchant users associated with the identified one of said plurality of merchant stores.

3. The invention of claim 2,
wherein one of said plurality of merchant users receives said complaint identifying said unique store associated with said one of said plurality of merchant users on said proprietary software.

4. The invention of claim 3,
wherein said plurality of merchant users associated with said identified unique store responds to said complaint.

5. The invention of claim 4,
wherein said unique user creates a complaint code associated with said complaint;
wherein said complaint code is given to a witness;
wherein said witness accesses said complaint and enters a complaint text into said complaint submission form associated with said complaint; and
wherein said witness accesses said complaint and enters a multimedia file into said complaint submission form associated with said complaint.

6. The invention of claim 5,
wherein said receiving occurs instantaneously.

7. The invention of claim 6,
wherein said response is an affirmative response;
wherein said resolution score associated with said unique store of said complaint is increased.

8. The invention of claim 7,
wherein said affirmative response comprises a face-to-face interaction.

9. The invention of claim 7,
wherein said affirmative response comprises a telephone interaction.

10. The invention of claim 7,
wherein said affirmative response comprises a text-based interaction.

11. The invention of claim 6,
wherein said response is a negative response;
wherein said resolution score associated with said unique store of said complaint is reduced.

12. The invention of claim 6,
wherein said response is a counter-complaint; and
wherein said reputation score associated with said unique user of said complaint is reduced.
